(19) United States
(12) Patent Application Publication
(10) Pub. No.: US 2014/0061314 A1
(43) Pub. Date: Mar. 6, 2014

(54) RFID DEVICE FOR NEAR-FIELD COMMUNICATION

(71) Applicants: CHING-CHIH CHAN, TAICHUNG CITY (TW); CHING-WEI CHANG, NEW TAIPEI CITY (TW)

(72) Inventors: CHING-CHIH CHAN, TAICHUNG CITY (TW); CHING-WEI CHANG, NEW TAIPEI CITY (TW)

(73) Assignee: AUDEN TECHNO CORP., TAOYUAN COUNTY (TW)

(21) Appl. No.: 13/605,988

(22) Filed: Sep. 6, 2012

(51) Int. Cl. G06K 19/073

(52) U.S. Cl. 235/492

(57) ABSTRACT

This instant disclosure illustrates a RFID device for near-field communication, comprising a substrate, a winding and a RFID circuit. The substrate includes a first surface and a second surface. The windings are spirally reeled and mounted on the first surface and the second surface. A plurality of winding distances are between the windings, and the winding distances are not larger than the first winding distance. The RFID circuit is mounted on the first surface or the second surface of the substrate, and electrically connected to both of winding ends.

### BACKGROUND

1. Technical Field

The present disclosure relates to the radio frequency identification (RFID), in particular, to the RFID device for near-field communication.

2. Description of Related Art

Please refer to FIG. 1A and FIG. 1B showing the front-view and back-view schematic drawings of a traditional RFID device for near-field communication of the prior art. As shown in FIG. 1A, a traditional RFID device 1 comprises a substrate (or called a circuit board) 10, a winding 11, a RFID circuit 12, a capacitive element 13, and a matching circuit 14. The winding 11, the RFID circuit 12, the capacitive element 13, and the matching circuit 14 is mounted on the substrate 10. The RFID circuit 12 is a circuit for the RFID operation, and can be implemented via an IC chip. The back surface of the substrate 10 can be formed by the winding 11. As shown in FIG. 1B, the winding 11 is usually circularly reeled and becomes a loop antenna. Also, the winding 11 is connected to the capacitive element 13 and the matching circuit 14 via the through-hole 101 of the substrate 10, and further connected to the RFID circuit 12.

The winding 11 of the traditional RFID device 1 is operated at 13.56 MHz and the impedance reaches to 50Ω via the capacitive element 13 and the matching circuit 14. Also, in the traditional RFID device 1, because of the stronger inductivity resulted from the length of the reeled wire of the winding 11, the winding 11 needs to be connected to the capacitive element 13 before it electrically connects to the RFID circuit 12, and further connects to the matching circuit 14. The capacity of the capacitive element 13 is for balancing the inductivity of the winding 11.

### SUMMARY

An exemplary embodiment of the present disclosure provides a RFID device for near-field communication, which avoids using the capacitive element by adjusting the reeled wire density of the winding, and further decreases the area or the size of the RFID device.

An exemplary embodiment of the present disclosure provides a RFID device comprising a substrate, a winding, a conducing cross-wire and a RFID circuit. The substrate has a first surface. The winding is spirally reeled and mounted on the first surface of the substrate, and has a plurality of winding distances which are not larger than a first winding distance. The conducting cross-wire is cross-wired on the first surface of the substrate and serially connected to the winding. The RFID circuit is mounted on the substrate and electrically connected to both of the ends of the winding

An exemplary embodiment of the present disclosure provides a RFID device, comprising a substrate, a winding, and a RFID circuit. The substrate has a first surface and a second surface. The winding is spirally reeled and mounted on the first surface and the second surface of the substrate. The winding has a plurality of winding distances which are not larger than the first winding distance. The RFID circuit is mounted on the first surface or the second surface of the substrate and electrically connected to both of the ends of the winding

An exemplary embodiment of the present disclosure provides a RFID device, comprising a substrate, a winding, and a RFID circuit. The substrate has a first surface. The winding has two winding ends, starting from each winding end, is spirally reeled and mounted on the first surface of the substrate. The winding has a plurality of winding distances which are not larger than the first winding distance. The RFID circuit is mounted on the substrate and electrically connected to both of the ends of the winding

To sum up, in the RFID device provided by the exemplary embodiments of this instant disclosure, the winding distances of the reeled winding can form capacitive impedance, and thus there's no need to use the capacitive element, which decreases the area of the winding and further deduces the size of the RFID device.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A is a front-view schematic drawing of a traditional RFID device for near-field communication of the prior art.

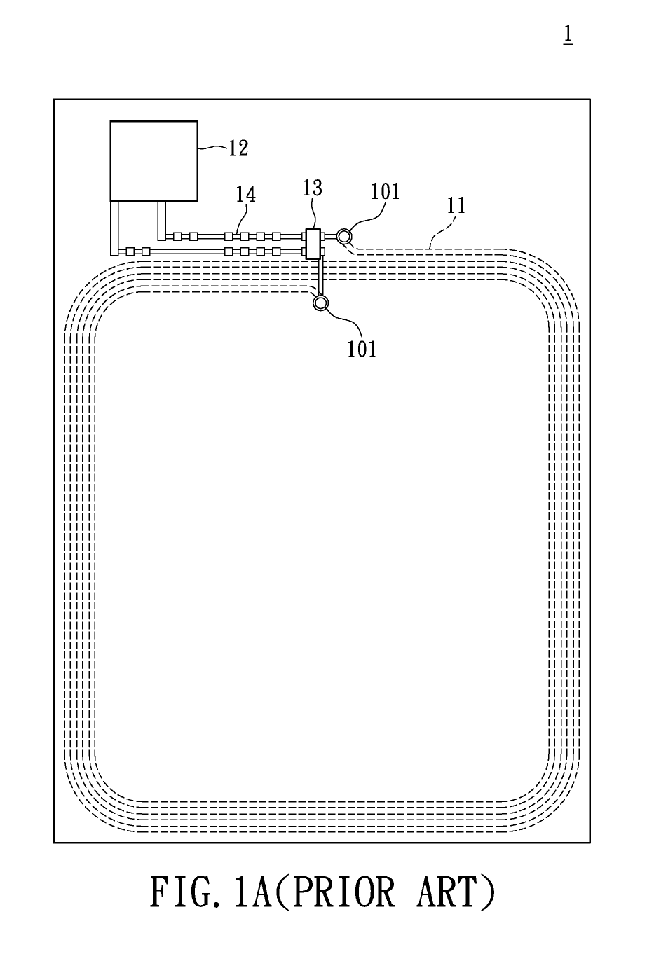

FIG. 1B is a back-view schematic drawing of a traditional RFID device for near-field communication of the prior art.

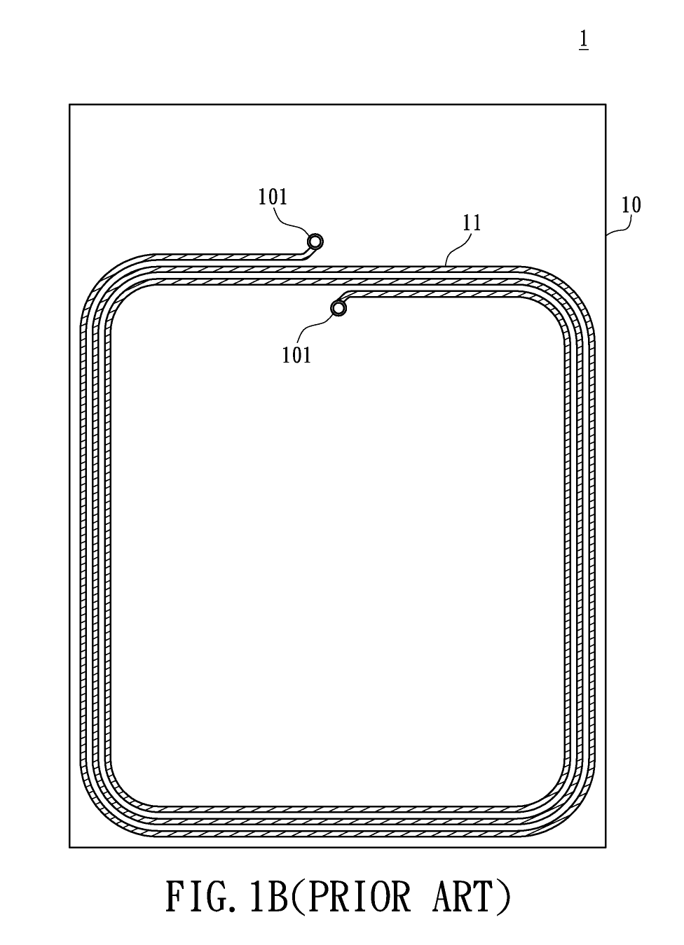

FIG. 2 is a schematic drawing of a RFID device for near-field communication of an embodiment of this instant disclosure.

FIG. 3A is a front-view schematic drawing of a RFID device for near-field communication of another embodiment of this instant disclosure.

FIG. 3B is a back-view schematic drawing of a RFID device for near-field communication of another embodiment of this instant disclosure.

FIG. 4 is a schematic drawing of a RFID device for near-field communication of another embodiment of this instant disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

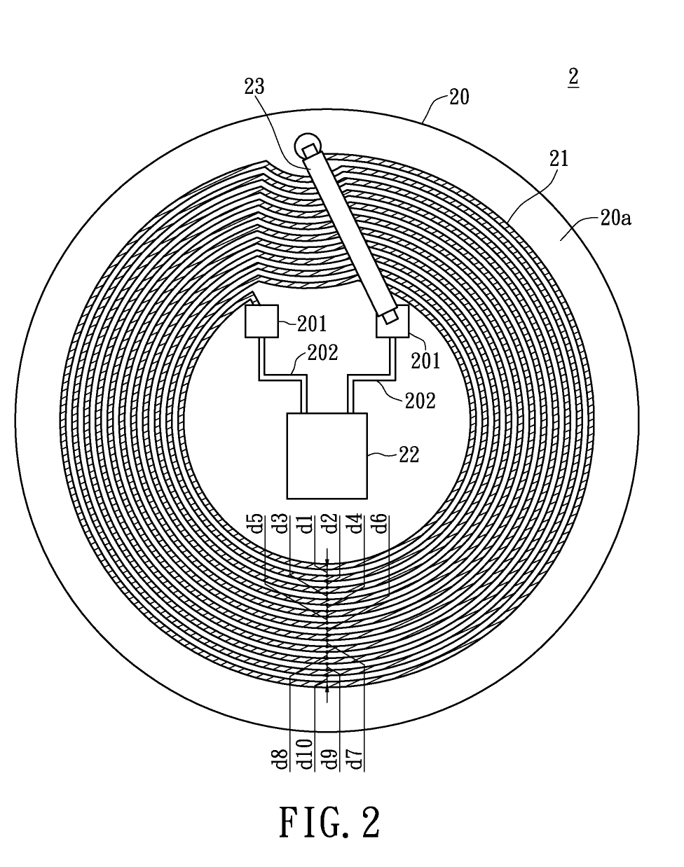

Please refer to FIG. 2 showing a schematic drawing of a RFID device for near-field communication of an embodiment of this instant disclosure. A RFID device 2 comprises a substrate 20, a winding 21, a conducting cross-wire 23 and a RFID circuit 22. The substrate 20 has a first surface 20a, that is, the surface shown in the FIG. 2. On the substrate 20, there're two conducting contact pads and two conducting wires 202 for conducting the winding 21 and the RFID circuit 22.

The winding 21 is spirally reeled and mounted on the first surface 20a of the substrate 20. The winding 21 has a plurality of winding distances d1, d2, d3, d4, d5, d6, d7, which are not larger than the first winding distance D. The first winding distance D will be explained later. The conducting cross-wire 23 is cross-wired on the substrate 20 (the first surface as shown in FIG. 2) and serially connected to the winding. The RFID circuit 22 is mounted on the substrate and electrically connected to both of the ends of the winding 21 via the conducting contact pad 201 and the conducting wire 202. The RFID circuit can also be mounted on other surfaces of the substrate 20, as long as the RFID circuit 22 can be electrically connected to the winding 21.

What is worth mentioning is that, the conducting contact pad 201 and the conducting wire 202 can also be part of the winding 21. The designer can adjust depends on the needs and decide whether or not to lay the conducting contact pad 201 and the conducting wire 202, which are merely for electrically connecting the winding 21 and the RFID circuit 22 with convenience. In other words, the winding 21, the conducting cross-wire 23, the conducting contact pad 201, and the conducting wire 202 form a loop structure of a loop antenna, and are conducted to the RFID circuit 22.

The substrate 22 can be a circuit board, for example, a glass fiber substrate or a ceramic substrate, while in this instant disclosure there's no intention to limit the material of the substrate 20. The winding 21, the conducting contact pad 201 and the conducting wire 202 on the substrate 20 can be produced via a PCB manufacturing process. After the winding 21, the conducting contact pad 201 and the conducting wire 202 are produced, in order to protect the structure of the winding 21, the conducting contact pad 201 and the conducting wire 202, there can be a layer of insulating material covered.

The conducting cross-wire can be an insulated metallic conductor. For example, when the winding 21 hasn't yet covered by a layer of insulating material, the two ends of the conducting cross-wire 23 can, respectively, be directly welded between the winding 21 and the conducting contact pad 201. When the conducting cross-wire 23 crosses the winding 21, the spirally reeled part of the conducting cross-wire 23 and the winding 21 won't be short-circuited, because the conducting cross-wire 23 (except for two ends of the conducting cross-wire 23) is insulating. On the other hand, the conducting cross-wire 23 can also be not insulating. When the conducting cross-wire 23 crosses the winding 21, the spirally reeled part of the conducting cross-wire 23 and the winding 21 would not be short-circuited, as long as the winding 21 is covered by a layer of insulating material.

Please again refer to FIG. 2. The distances d1, d2, d3, d4, d5, d6, d7, can be equal or not, as long as they're not larger than the first distance D. The first distance D can be from 0.1 mm to 1 mm, so that there would be the capacitive impedance formed between the adjacent conducting wires of the winding 21 to replace the capacitive element the traditional RFID device needs.

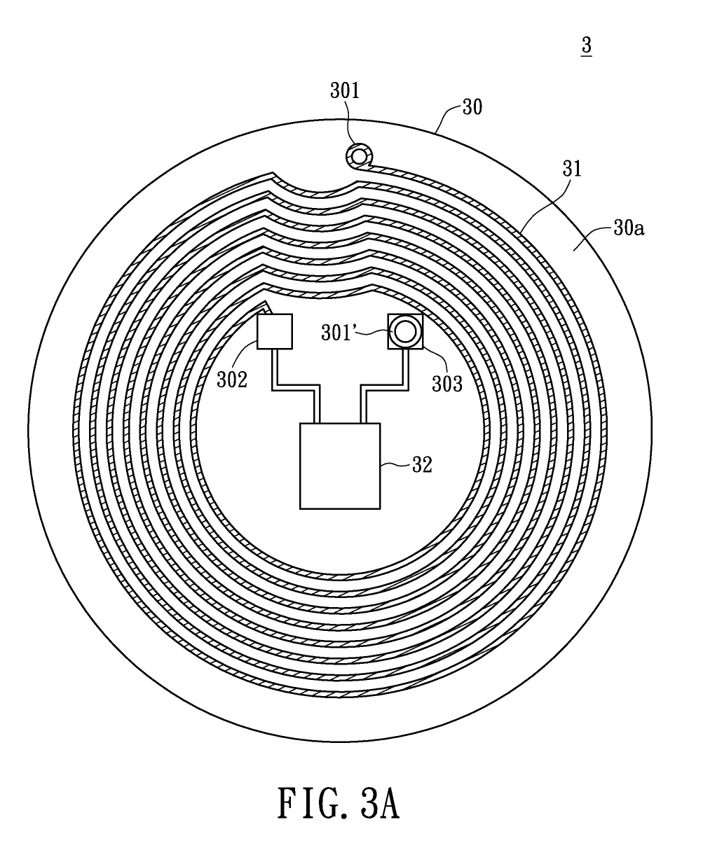

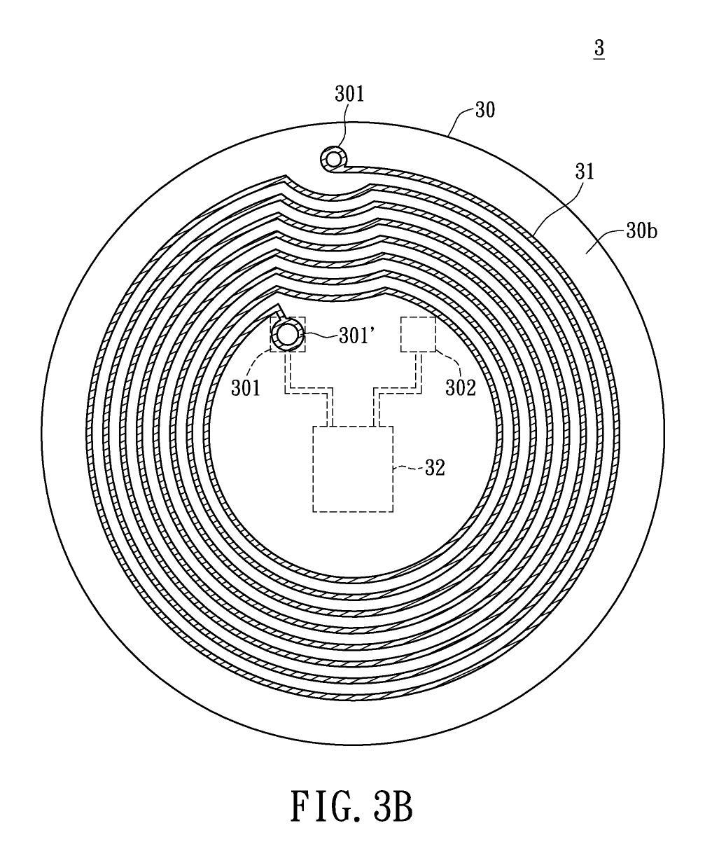

Please refer to FIG. 3A and FIG. 3B. FIG. 3A is a front-view schematic drawing of a RFID device for near-field communication of another embodiment of this instant disclosure. FIG. 3B is a back-view schematic drawing of a RFID device for near-field communication of another embodiment of this instant disclosure. A RFID device 3 is roughly the same as the RFID device 2, and the difference is merely that a winding 31 is mounted on the first surface 30a and the second surface 30b of a substrate 30. Accordingly, the RFID device 3 doesn't need the conducting cross-wire 23 the RFID device 2 has. About the detailed description of the RFID device 3, please refer to the following description.

As shown in FIG. 3, the RFID 3 comprises a substrate 30, a winding 31 and a RFID circuit 32. The substrate 30 has the first surface 30a and the second surface 30b. The first surface 30a of the substrate 30 has conducting contact pads 302, 303 (and the conducting wire connected to the RFID circuit 32), and through-holes 301, 301′. The substrate 30 can be a glass fiber substrate, such as a frequently used substrate FR4. The substrate 30 can also be a ceramic substrate, while in this instant disclosure there's no intention to limit the material of the substrate 30.

The winding 31 is spirally reeled and mounted on the first surface 30a and the second surface 30b of the substrate 30. The winding 31 has a plurality of winding distances, and in this embodiment the winding distances are equal; however, in this instant disclosure there's no intention to limit the winding distances of the winding 31, as long as the winding distances are not larger than the first distance D. The first distance D can be from 0.1 mm to 1 mm. The RFID circuit 32 is mounted on the first surface 30a or the second surface 30b of the substrate 30 and electrically connected to two ends of the winding 31. In FIG. 3A, the RFID circuit 32 is mounted on the first surface 30a of the substrate 30; however, in this instant disclosure there's no intention to limit, the RFID circuit 32 can also easily mounted on the second surface 30b of the substrate 30 by the through-holes.

Please again refer to FIG. 3A and FIG. 3B. Regarding the way of mounting the winding 31, the winding 31 is spirally reeled and mounted on the first surface 30a, from the end connected to the conducting contact pad 302 to the through-hole 301 and then, via the through-hole 301, continually spirally reeled and mounted on the second surface 30b until the winding 31 reaches the through-hole 301′. From the above, the winding 31 is spirally reeled on two surfaces of the substrate 30 such that there would be capacitive impedance formed between the adjacent conducting wires of the winding 31. Thus, the conducting wire of the winding 31 on the first surface 30a and the conducting wire of the winding 31 on the first surface 30b can trigger the capacity effect (that is, the conducting wires of the winding 31 on the upper surface and the bottom surface of the substrate 30 can trigger the capacity effect), so that the capacitive element the traditional RFID device needs can be replaced. Moreover, the winding 31 can be spirally reeled with a radius about 7.5 mm, and thus the size of the substrate 30 can be deduced and small like a coin or a button.

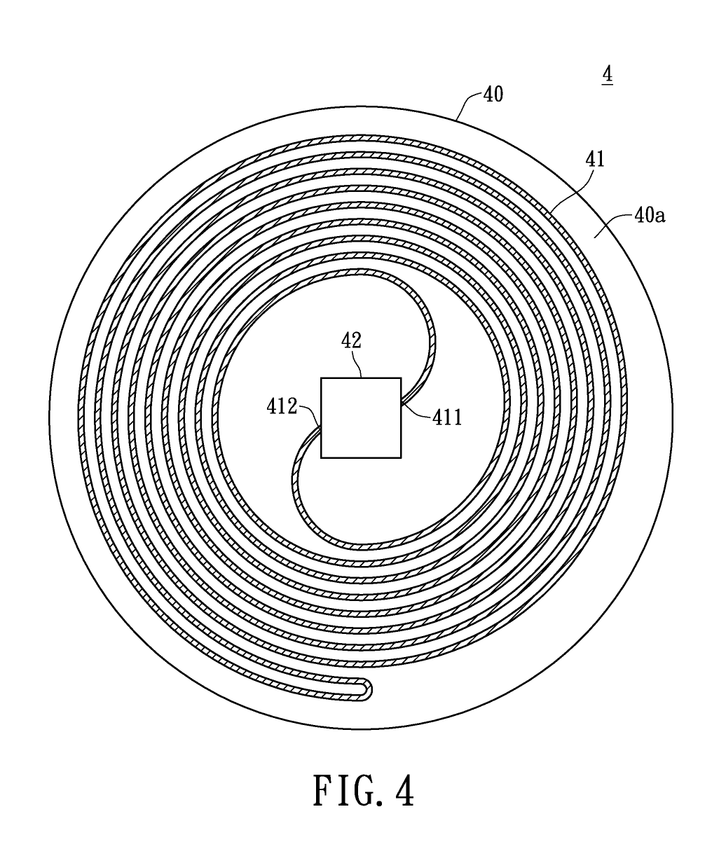

Please refer to FIG. 4. FIG. 4 is a schematic drawing of a RFID device for near-field communication of another embodiment of this instant disclosure. The difference between a RFID device 4 and the RFID device 2 and 3 in the above embodiments is that the winding 41 is not only mounted on the first surface 40a of the substrate 40 but doesn't need the conducting cross-wire 23 the RFID device 2 needs. About the detailed features of the RFID device 4, please refer to the following description.

The RFID device 4 comprises a substrate 40, a winding 41 and a RFID device circuit 422. The substrate 40 has a first surface 40a, that is, the surface shown in FIG. 4. The winding 41 has winding ends 411 and 412, for conducting the winding 41 and the RFID circuit 42. The substrate 40 can be a glass fiber substrate or a ceramic substrate.

The winding 41 is spirally reeled and mounted on the first surface 40a of the substrate 40, and the winding 41 has a plurality of winding distances, that is, the distances of the adjacent conducting wires of the winding 41, wherein the winding distances are not larger than the first distance D. As mentioned in above embodiments, the first distance D can be from 0.1 mm to 1 mm. The RFID circuit 42 is mounted on the substrate 40 and electrically connected to the winding 41 with the winding ends 411 and 412 of the winding 41. As shown in FIG. 4, the RFID device circuit 42 is mounted on the first surface 40a of the substrate 40; however, in this instant disclosure there's no intention to limit which surface the RFID device circuit 42 is mounted on. The RFID circuit 42 can also be mounted on other surfaces of the substrate 41, as long as the RFID circuit 42 and the winding 41 can be conducted via the through-holes.

What is worth mentioning is, when the winding 41 is spirally reeled, the most peripheral and the terminal conducting wire of the winding 41 are eventually connected. In other words, the winding 41 is spirally reeled outward with the winding ends 411 and 412 as start points and after that the two ends would be connected together at the most peripheral part of the winding 41 to become a loop antenna. The winding 41 which is spirally reeled can form a capacitive element so that the capacitive element the traditional RFID device used isn't needed.

In summary, according to the embodiments of this instant disclosure, in the RFID device for near-field communication, the distances formed by the spirally reeled winding can form capacitive impedance, so that there's no need to use a capacitive element and further the area of the winding can be deduced and the size of the RFID device can be smaller than the size of the traditional RFID device. Also, the winding can be spirally and tightly reeled on one or two surfaces of a substrate (or a circuit board), so that it can increase the convenience of the use of the RFID device for near-field and further expand the range of the application of the RFID device.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

1. (canceled)

2. (canceled)

3. (canceled)

4. (canceled)

5. A RFID device, comprising:
a substrate, having a first surface and a second surface, wherein the substrate is a FR4 substrate;
a winding, spirally reeled to be a loop antenna operating in 13.56 MHz and mounted on the first surface and the second surface of the substrate, and having a winding distance which is not larger than a first winding distance, wherein the first winding distance is from 0.1 mm to 1 mm and the winding is spirally reeled with a radius of 7.5 mm; and
a RFID circuit, mounted on the first surface or the second surface of the substrate, located at the inside of the winding, and electrically connected to both of a ends of the winding.

6. (canceled)

7. (canceled)

8. A RFID device, comprising:
a substrate, having a first surface;
a winding, having two winding ends, starting from each winding end, spirally reeled and mounted on the first surface of the substrate, and having a plurality of winding distances which are not larger than a first winding distance, wherein the winding is spirally reeled outward with the two winding ends as start points and the two winding ends is connected together at the most peripheral part of the winding to become a loop antenna; and
a RFID circuit, mounted on the substrate, located at the inside of the winding, and electrically connected to both of the ends of the winding.

9. The RFID device according to claim 8, wherein the winding distances are equal.

10. The RFID device according to claim 8, wherein the first winding distance is from 0.1 mm to 1 mm.
